(19) United States
(12) Patent Application Publication
(10) Pub. No.: US 2023/0374319 A1
(43) Pub. Date: Nov. 23, 2023

(54) FIRE-RESISTANT COMPOSITIONS

(71) Applicant: Hexion Inc., Columbus, OH (US)

(72) Inventors: Daniel PACHECO, Eugene, OR (US); Kevin FORTIER, Sammamish, WA (US)

(21) Appl. No.: 17/750,904

(22) Filed: May 23, 2022

(51) Int. Cl. C09D 5/18; C09D 7/43; C08K 3/015; C08K 9/10; C08K 7/26

(52) U.S. Cl. CPC C09D 5/185; C09D 7/43; C08K 3/015; C08K 9/10; C08K 7/26

(57) ABSTRACT

Embodiments of the present disclosure generally relate to fire-resistant compositions and to coated substrates and articles comprising such compositions. In an embodiment, a fire-resistant composition is provided. The fire-resistant composition includes particles having a core-shell structure. The fire-resistant composition further includes an intumescent, a blowing agent, a catalyst, and a binder. In another embodiment, a coated substrate is provided. The coated substrate includes a substrate having a fire-resistant composition disposed thereon. In another embodiment, a fire-resistant article is provided. The fire-resistant article includes a flexible substrate having a fire-resistant composition disposed thereon.

### FIELD

Embodiments of the present disclosure generally relate to fire-resistant compositions and to coated substrates and articles comprising such compositions.

### BACKGROUND

The safety and reliability of residential and commercial buildings, as well as power infrastructure such as utility poles, is paramount. Conventional technologies such as fire-resistant compositions and wraps or sleeves comprising fire-resistant compositions are utilized to protect such structures while minimizing the cost of disruption and repair. Such fire-resistant compositions typically include intumescents that swell upon exposure to heat. However, many intumescents contain graphite flakes which are inherently electrically conductive. Lower electric conductivity can be beneficial in limiting electric arcs and electrical flash events. Beyond electrical conductivity, conventional fire-resistant compositions may not be suitable with lignocellulose and wood materials. Moreover, the weight added to the structures by using conventional coating compositions can cause additional mechanical stress on building materials and structures.

There is a need for new and improved fire-resistant compositions and to coated substrates and articles comprising fire-resistant compositions

### SUMMARY

Embodiments of the present disclosure generally relate to fire-resistant compositions and to coated substrates and articles comprising such compositions. Relative to conventional fire-resistant compositions, the fire-resistant compositions described herein can have lower electrical conductivity, while being suitable for a large variety of substrates such as wood and metal, among others. In addition, the fire-resistant compositions described herein can be lighter in weight relative to conventional fire-resistant compositions.

In an embodiment, a fire-resistant composition is provided. The composition includes a plurality of particles, each particle of the plurality of particles comprising a core and a shell, the shell comprising ceramic, glass, polymer, resin, or combinations thereof. The composition further includes an intumescent; a blowing agent; a catalyst; and a binder comprising a thermoplastic compound and a thermoset compound.

In another embodiment, a coated substrate is provided. The coated substrate includes a substrate and a fire-resistant composition disposed over at least a portion of the substrate. The fire-resistant composition of the coated substrate includes: particles having a core-shell structure, the shell comprising ceramic, glass, polymer, resin, or combinations thereof; an intumescent; a blowing agent; a catalyst; and a binder comprising a thermoplastic compound and a thermoset compound.

In another embodiment, a fire-resistant article is provided. The fire-resistant article includes a flexible substrate and a fire-resistant composition disposed on at least a portion of the flexible substrate. The fire-resistant composition of the coated substrate includes: particles having a core-shell structure, the shell comprising ceramic, glass, polymer, resin, or combinations thereof, the particles having an average particle size of about 0.5 μm to about 2,000 μm; an intumescent; a blowing agent; and a binder comprising a thermoplastic compound and a thermoset compound.

### BRIEF DESCRIPTION OF THE DRAWINGS

So that the manner in which the recited features of the present disclosure can be understood in detail, a more particular description of the embodiments, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a top plan view of an example fire-resistant article according to at least one embodiment of the present disclosure.

FIG. 2 is a side view of an example flexible substrate having a fire-resistant composition disposed thereon according to at least one embodiment of the present disclosure.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to fire-resistant compositions and to coated substrates and articles comprising such compositions. The fire-resistant compositions can include hollow particles (for example, ceramic microspheres) that can reduce the electrical conductivity, thermal energy transfer, and the weight of the fire-resistant compositions relative to conventional fire-resistant compositions. The fire-resistant compositions described herein can enable increased stability while reducing the use of dispersants, surfactants, and rheological modifiers relative to conventional fire-resistant compositions. The fire-resistant compositions also show good durability upon curing. Here, it was observed that after intumescence, embodiments described herein have less flaking of intumescent compounds relative to conventional fire-resistant compositions. While not wishing to be bound by theory, the particles (such as hollow ceramic microspheres) can provide added density to the composition, limiting the amount of flaking and making the compositions less brittle. As described below, the fire-resistant compositions can be utilized in a variety of applications, such as fire-resistant coatings for utility poles, residential buildings, and commercial buildings, as well as structures to be fire-resistant. In addition, and as further described below, the fire-resistant compositions can be coated on a substrate, such as a substrate having a mesh structure or open-cell structure, and the resultant article can be affixed to infrastructure equipment, residential building materials and structures, commercial building materials and structures, among other structures and installations.

Embodiments described herein generally relate to fire-resistant compositions. The fire-resistant compositions can include particles, an intumescent (expandable graphite compound), a blowing agent, a catalyst, and a binder. In some embodiments, the fire-resistant compositions described herein can optionally include additives.

As used herein, a “composition” can include component(s) of the composition, reaction product(s) of two or more components of the composition, a remainder balance of remaining starting component(s), or combinations thereof. Compositions of the present disclosure can be prepared by any suitable mixing process.

The fire-resistant compositions include particles. The particles can be made from, or include, a non-conductive material or materials having high electrical resistivity. For example, the electrical resistivity of the particles can be about 1×10¹² ohm·cm or more, such as about 1×10¹⁴ ohm·cm or more, such as about 1×10¹⁴ ohm·cm to about 1×10¹⁷ ohm·cm. The particles can additionally, or alternatively, have low thermal conductivity. For example, the thermal conductivity of the particles, in units of Watt per meter Celsius (W/m⁻¹/° C.) is about 1 or less, such as about 0.5 or less, such as about 0.3 or less, or from about 0.05 to about 0.9.

The particles can have a core-shell structure. The shell of the particles can be made from any suitable material such as a ceramic material, a glass material, a polymer material, or a resin material such as a phenolic resin, or combinations thereof. The ceramic material can be made from, or include, silicon oxide, aluminium oxide, iron oxide, titanium dioxide, or combinations thereof, in any suitable proportions. The core of the particles can be hollow, at least partially hollow, at least partially filled, or filled. The core can contain a vacuum, a partial vacuum, no vacuum (atmosphere), a liquid material, a gaseous material, a solid material, or combinations thereof When the particles are at least partially hollow, the fire-resistant compositions can be lighter in weight relative to conventional fire-resistant compositions, while at the same time having equivalent or superior performance to conventional fire-resistant compositions. For example, the fire-resistant compositions described herein can have a weight that is about 40% lighter, or even lighter, than an equivalent amount of conventional compositions for fire resistance. Here, conventional cementitious coatings rated for fire resistance add about 6.8 kg to about 9.1 pounds of additional dry weight. In contrast, and in some examples, the use of particles such as hollow ceramic microspheres as described herein only adds about 1.5 to about 1.8 pounds of additional dry weight at an equivalent application thickness. This represents a coating that is about 73% lighter.

The particles can be of any suitable shape such as spherical, substantially spherical, non-spherical, or substantially non-spherical. The particles can be of any suitable size. In some embodiments, the particles can be nanopartieles, microparticles, or macroparticles.

The particles can have an average particle size that is from about 0.5 μm to about 2,000 μm, such as from about 50 μm to about 1,000 μm, such as from about 100 μm to about 500 μm, such as from about 200 μm to about 400 μm, though other average particle sizes are contemplated. In at least one embodiment, the average particle size of the particles is from about 5 μm to about 900 μm, such as from about 10 μm to about 500 μm, such as from about 20 μm to about 400 μm, such as from about 50 μm to about 350 μm, such as from about 25 μm to about 375 μm, such as from about 50 μm to about 350 μm, such as from about 75 μm to about 325 μm, such as from about 100 μm to about 300 μm, such as from about 125 μm to about 275 μm, such as from about 150 μm to about 250 μm, such as from about 175 μm to about 225 μm, such as from about 175 μm to about 200 μm or from about 200 μm to about 225 μm.

The average particle size (μm) of the particles can be 1, 5, 10, 20, 50, 100, 150, 200, 250, 300, 350, 400, 450, 500, 550, 600, 650, 700, 750, 800, 850, 900, 950, 1,000, 1,100, 1,200, 1,300, 1,400, 1,500, 1,600, 1,700, 1,800, 1,900, 2,000 or ranges thereof, though higher or lower average particle sizes are contemplated. Each of the foregoing numbers can be preceded by the word “about,” “at least about,” “less than about,” or “more than about,” and any of the foregoing numbers can be used singly to describe an open-ended range or in combination to describe a close-ended range.

The particles can have a relative density that is less than about 1 g/cc, such as about 0.9 g/cc or less, such as about 0.5 g/cc to about 0.9 g/cc, such as from about 0.6 glee to about 0.85 g/cc, such as from about 0.65 g/cc to about 0.8 g/cc, though different densities are contemplated. In some examples, the particles can have a compressive strength that is greater than about 10 MPa, such as from about 10 MPa to about 50 MPa, such as from about 20 MPa to about 40 MPa, such as from about 25 MPa to about 35 MPa, though a higher or lower compressive strength of the particles is contemplated. The high compressive strength can impart impact resistance to the compositions and may deter destruction due to wildlife or environmental elements.

One or more types of particles can be used with fire-resistant compositions described herein. Commercially available examples of particles include, but are not limited to, hollow ceramic spheres such as E-Spheres, such as E-Spheres SL500, E-Spheres SL350, E-Spheres SL300, E-Spheres SLG, E-Spheres SL150, E-Spheres SL125, and E-Spheres SL75 commercially available from Envirospheres Pty Ltd. Other useful particles include Extendospheres SLG which are hollow ceramic spheres commercially available from Sphere One Inc.

A total amount of particles in a fire-resistant composition described herein can be from about 0.5 wt % to about 20 wt %, such as from about 1 wt % to about 15 wt %, such as from about 2 wt % to about 10 wt %, such as from about 4 wt % to about 8 wt %, based on a total weight of the fire-resistant composition, the total weight of the fire-resistant composition not to exceed 100 wt %. In some embodiments, the total amount (in wt %) of the particles in a fire-resistant composition, based on the total weight of the fire-resistant composition, can be 0.5, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, or 20, or ranges thereof, though higher or lower amounts are contemplated. Each of the foregoing numbers can be preceded by the word “about,” “at least about,” “less than about,” or “more than about,” and any of the foregoing numbers can be used singly to describe an open-ended range or in combination to describe a close-ended range.

Fire-resistant compositions described herein further include one or more intumescents. Intumescents are substances that expand upon exposure to heat, thereby increasing in volume and decreasing in density.

The one or more intumescents can include expandable graphite. Expandable graphite can also be referred to as expandable flake graphite, intumescent flake graphite, or expandable flake. The one or more intumescents can include an expandable graphite compound having a mean particle size in the range of about 300 μm to about 1,000 μm, such as from about 375 μm to about 950 μm, such as from about 400 μm to about 800 μm, such as from about 450 μm to about 700 μm, such as from about 500 μm to about 600 μm. The one or more intumescents can include an expandable graphite compound having a mean particle size in the range of about 0.5 μm to about 250 μm, such as from about 5 μm to about 200 μm, such as from about 20 μm to about 175 μm, such as from about 50 μm to about 150 μm, such as from about 75 μm to about 125 μm.

The one or more intumescents can include (a) a first expandable graphite compound having a mean particle size in the range of from 300 microns to 1000 microns; and (b) a second expandable graphite compound having a mean particle size in the range of from 0.5 microns to 250 microns. A weight ratio of the first expandable graphite compound to the second expandable graphite compound can be about 10:1 to about 1:10, such as from about 5:1 to about 1:5, such as from about 4:1 to about 1:4, such as from about 3:1 to about 1:3, such as from about 2:1 to about 1:2, such as about 1:1, though higher or lower weight ratios are contemplated.

Examples of expandable graphite can include, but are not limited to, Nyagraph 35, Nyagraph 251, Nyagraph 351 (commercially available from Nyacol Nano Technologies, Inc., Ashland, Mass.), Grafguard 160-50N, and Grafguard 200-100N (commercially available from Graf Tech International, Brooklyn Heights, Ohio).

One or more types of intumescents can be used with fire-resistant compositions described herein.

A total amount of the one or more intumescents (for example, a total amount of expandable graphite compounds) in a fire-resistant composition described herein can be from about 5 wt % to about 30 wt %, such as from about 5 wt % to about 25 wt %, such as from about 7 wt % to about 20 wt %, such as from about 10 wt % to about 18 wt %, such as from about 12 wt % to about 16 wt %, based on the total weight of the fire-resistant composition. In some embodiments, a total amount, in wt %, of the one or more intumescents in a fire-resistant composition, based on the total weight of the fire-resistant composition, can be 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, 25, 25.5, 26, 26.5, 27, 27.5, 28, 28.5, 29, 29.5, or 30, or ranges thereof, though higher or lower amounts are contemplated. Each of the foregoing numbers can be preceded by the word “about,” “at least about,” “less than about,” or “more than about,” and any of the foregoing numbers can be used singly to describe an open-ended range or in combination to describe a close-ended range.

The fire-resistant compositions can also include a binder. The binder can include at least one thermoplastic compound and at least one thermoset compound. Binders can perform several functions in the fire-resistant compositions described herein. The binder can act as a matrix in which the other components of the fire-resistant composition are dispersed. The binder can also bind the fire-resistant composition to a substrate. Additionally, the binder can contribute to the insulating char layer formed by the expansion of the fire-resistant composition,

The thermoplastic compound can be present in the fire-resistant composition as a dispersion. The dispersion can be prepared by any suitable method known to those skilled in the art. In various embodiments, the dispersion is prepared via an emulsion.

Illustrative, but non-limiting, examples of thermoplastic compounds that can be used include polyvinyl acetate, poly(methyl acrylate), poly(methyl methacrylate), poly(ethyl acrylate), poly(ethyl methacrylate), poly(n-butyl acrylate), poly(n-butyl methacrylate), poly(isobutyl acrylate), poly(isobutyl methacrylate), poly(tert-butyl acrylate), poly(tert-butyl methacrylate), poly(2-hydroxyethyl acrylate), poly(2-hydroxyethyl methacrylate), poly(2-hydroxypropyl acrylate), poly(2-hydroxypropyl methacrylate), poly(2-ethylhexyl acrylate), poly(2-ethylhexyl methacrylate), and combinations thereof. Commercially available thermoplastic compounds include Multibond 1P2, which is a crosslinking polyvinyl acetate and Covinax FR-A 707 (a styrene acrylic thermoplastic compound commercially available from Franklin International), among others.

The thermoset compound is optionally present in the fire-resistant composition as a dispersion. The thermoset dispersion can be prepared by any suitable method known to those skilled in the art, such as by slow addition of a resin into a system that contains an emulsifying agent.

Illustrative, but non-limiting, examples of thermoset compounds that can be used include phenol formaldehyde, urea formaldehyde, melamine formaldehyde, melamine reinforced urea formaldehyde, isocyanate reinforced urea formaldehyde resin, resorcinol formaldehyde resin, polyacrylic latex resin, isocyanate resin, an organopolysiloxane, ethylene glycol, bisphenol-A epoxy resins, bisphenol-F epoxy resins, unsaturated polyesters, polyurethane, and combinations thereof. Commercially available thermoset compounds can include XB-91MO (Flexion, Inc.), which is a phenolic thermoset compound. Other commercially available thermoset compounds can include, but are not limited to, Cascophen phenol formaldehyde resin and Cascophen phenol resorcinol formaldehyde resin, Cascomel melamine formaldehyde resin, and Casco urea formaldehyde resin, among others, each of which is commercially available from Hexion, Inc.

A weight ratio of the thermoplastic compound to the thermoset compound in the binder can be in the range of about 10:1 to about 1:3, such as from about 8:1 to about 1:2.5, such as from about 6.5:1 to about 1:2, such as from about 6:1 to about 1:1.5, such as from about 5:1 to about 1:1, such as from about 3:1 to about 1.5:1. In some embodiments, the weight ratio of the thermoplastic compound to the thermoset compound in the binder can be 10:1, 9.5:1, 9:1, 8.5:1, 8:1, 7.5:1, 7:1, 6.5:1, 6:1, 5.5:1, 5:1, 4.5:1, 4:1, 3.5:1, 3:1, 2.5:1, 2:1, 1.5:1, 1:1, 1:1.5, 1:2, 1:2.5, or 1:3, or ranges thereof, though other weight ratios are contemplated. Each of the foregoing numbers can be preceded by the word “about,” “at least about,” “less than about,” or “more than about,” and any of the foregoing numbers can be used singly to describe an open-ended range or in combination to describe a close-ended range.

A total amount of binder in fire-resistant compositions described herein can be from about 10 wt % to about 80 wt %, such as from about 15 wt % to about 65 wt %, such as from about 20 wt % to about 55 wt %, such as from about 30 wt % to about 50 wt %, based on the total weight of the fire-resistant composition. The total amount of binder in the fire-resistant composition is the total weight of the thermoplastic compound(s) and the thermoset compound(s).

In some embodiments, a total amount (in wt %) of binder in a fire-resistant composition, based on the total weight of the fire-resistant composition, can be 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, or 80, or ranges thereof, though higher or lower amounts are contemplated. Each of the foregoing numbers can be preceded by the word “about,” “at least about,” “less than about,” or “more than about,” and any of the foregoing numbers can be used singly to describe an open-ended range or in combination to describe a close-ended range.

The fire-resistant compositions described herein can also include one or more blowing agents. Blowing agents can be useful for expanding the binder in order to increase the thickness of the fire-resistant composition. The blowing agent can also serve to dilute the concentrations of combustible gasses that are released when a wood substrate burns. Examples of blowing agents that can be used include, but are not limited to, melamine, urea, butyl urea, alumina trihydrate, dicyandiamide, benzene sulfonyl-hydrazide, azobisisobutyronitrile, 1,1-azobisformamide, 4,4′ oxybis(benzene sulfonhydrazide), dinitroisopentamethylene tetraamine, and combinations thereof. One or more types of blowing agents can be used with compositions described herein.

In various embodiments, the melamine used can be Melafine (OCI Nitrogen). Blowing agents can include solid carbonate species such as calcium carbonate, sodium carbonate, sodium bicarbonate, potassium carbonate, or combinations thereof Liquid carbonates can also be used as blowing agents such as propylene carbonate and solutions or slurries of calcium carbonate sodium carbonate, sodium bicarbonate, potassium carbonate, or combinations thereof. Commercially available blowing agents can also include, but are not limited to, Microna 3 (calcium carbonate) commercially available from Columbia River Carbonates, and Imasco 511 (limestone) commercially available from Imasco Minerals Inc.

A total amount of blowing agent(s) in fire-resistant compositions described herein can be from about 1 wt % to about 35 wt %, such as from about 5 wt % to about 30 wt %, such as from about 10 wt % to about 25 wt %, such as from about 15 wt % to about 20 wt %, based on the total weight of the fire-resistant composition. In some embodiments, the total amount (in wt %) of blowing agent(s) in a fire-resistant composition, based on the total weight of the fire-resistant composition, can be 0.5, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, 25, 25.5, 26, 26.5, 27, 27.5, 28, 28.5, 29, 29.5, 30, 30.5, 31, 31.5, 32, 32.5, 33, 33.5, 34, 34.5, or 35, or ranges thereof, though higher or lower amounts are contemplated. Each of the foregoing numbers can be preceded by the word “about,” “at least about,” “less than about,” or “more than about,” and any of the foregoing numbers can be used singly to describe an open-ended range or in combination to describe a close-ended range.

The fire-resistant compositions described herein can also include one or more catalysts. The catalysts can be useful to assist with the intumescent expansion of the fire-resistant composition. Illustrative, but non-limiting, examples of catalysts include perchloric acid, hydroiodic acid, hydrobromic acid, sulfuric acid, hydrochloric acid, nitric acid, sulfurous acid, phosphoric acid, nitrous acid, sulfonic acid, hydrochloric acid, sulfuric acid, phosphoric acid, foul& acid, acetic acid, maleic acid, malic acid, tartaric acid, citric acid, ammonium phosphates, ammonium polyphosphates, metal phosphates, metal polyphosphates, paratoluene sulfonic acid, and combinations thereof. One or more types of catalysts can be used with the fire-resistant compositions described herein. Commercially available catalysts can include, but are not limited to, Exolit AP 422 (an ammonium polyphosphate, Clariant International Ltd). Ammonium polyphosphate can also act as a blowing agent.

A total amount of catalyst(s) in fire-resistant compositions described herein can be from about 1 wt % to about 20 wt %, such as from about 2 wt % to about 15 wt %, such as from about 3 wt % to about 12 wt %, such as from about 4 wt % to about 10 wt %, such as from about 6 wt % to about 8 wt %, based on the total weight of the fire-resistant composition. In some embodiments, the total amount (in wt %) of catalyst(s) in a fire-resistant composition, based on the total weight of the fire-resistant composition, can be 0.5, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, or 20, or ranges thereof, though higher or lower amounts are contemplated. Each of the foregoing numbers can be preceded by the word “about,” “at least about,” “less than about,” or “more than about,” and any of the foregoing numbers can be used singly to describe an open-ended range or in combination to describe a close-ended range.

The fire-resistant compositions described herein can also include a variety of optional additives, depending on the application. Illustrative, but non-limiting, examples of additives can include a viscosity reducer, a dispersant, a defoamer, a pigment, a coalescing agent, a rheological modifier, a toxic gas absorbing material, an absorbent promoter, a wetting agent, a nucleating agent, an accelerator, a filler, a buffer, a reinforcing additive, a surfactant, a thickener, or combinations thereof in any suitable amounts or proportions.

Commercially available optional additives include, but are not limited to: Disperbyk-190 (a dispersant) commercially available from BYK-Chemie GmbH, Byk-037 (a volatiles-free, silicone-containing defoamer) commercially available from BYK-Chemie GmbH; iron oxide (a pigment) commercially available from Sigma Aldrich; 2,2,4-trimethyl-1,3-pentanediol monoisobutyrate (a coalescing agent) also known as Texanol commerically available from Sigma Aldrich and NX 795 commercially available from Synthomer PLC; Thixol 53L (a liquid acrylic thickener or rheological modifier) commercially available from Arkema; Rheotech 3800 (a thickener) commercially available from Arkema; Natrosol 250 HR (a thickener) commercially available from Ashland Global Specialty Chemicals Inc.; or combinations thereof.

A total amount of optional additive(s), excluding water, in fire-resistant compositions described herein can be about 20 wt % or less, such as about 15 wt % or less, such as about 10 wt % or less, such as from about 0 wt % of about 10 wt %, such as from about 0.5 wt % to about 8 wt %, such as from about 1 wt % to about 6 wt %, such as from about 2 wt % to about 5 wt %, such as from about 3 wt % to about 4 wt %. In some embodiments, the total amount (in wt %) of optional additive(s) in a fire-resistant composition, based on the total weight of the fire-resistant composition, can be 0, 0.25, 0.5, 0.75, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, or 20, or ranges thereof, though higher or lower amounts are contemplated. Each of the foregoing numbers can be preceded by the word “about,” “at least about,” “less than about,” or “more than about,” and any of the foregoing numbers can be used singly to describe an open-ended range or in combination to describe a close-ended range.

In some embodiments, the fire-resistant composition can also include water. An amount of water in the fire-resistant composition can be about 40 wt % or less, such as from about 0 wt % to about 30 wt %, such as from about 5 wt % to about 20 wt %, such as from about 10 wt % to about 18 wt %. In at least one embodiment, the total amount (in wt %) of water in a fire-resistant composition, based on the total weight of the fire-resistant composition, can be 0, 0.25, 0.5, 0.75, 1, 1.5, 2, 2.5, 3, 3.5, 4, 4.5, 5, 5.5, 6, 6,5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, 25, 25.5, 26, 26.5, 27, 27.5, 28, 28.5, 29, 29.5, or 30, or ranges thereof, though other amounts are contemplated. Each of the foregoing numbers can be preceded by the word “about,” “at least about,” “less than about,” or “more than about,” and any of the foregoing numbers can be used singly to describe an open-ended range or in combination to describe a close-ended range.

In some embodiments, a total amount of dispersant(s) in fire-resistant compositions described herein can be from about 0 wt % to about 10 wt %, such as from about 0.1 wt % to about 8 wt %, such as from about 0.25 wt % to about 3 wt %, based on the total weight of the fire-resistant composition. In at least one embodiment, the total amount (in wt %) of dispersant(s) in a fire-resistant composition, based on the total weight of the fire-resistant composition, can be 0, 0.25, 0.5, 0.75, 1, 1.5, 2, 2.5, 3, 3.5, 4, 4,5, 5, 5.5, 6, 6.5, 7, 7.5, 8, 8.5, 9, 9.5, or 10, or ranges thereof, though other amounts are contemplated. Each of the foregoing numbers can be preceded by the word “about,” “at least about,” “less than about,” or “more than about,” and any of the foregoing numbers can be used singly to describe an open-ended range or in combination to describe a close-ended range.

In some embodiments, a total amount of defoamer(s) in fire-resistant compositions described herein can be from about 0 wt % to about 11 wt %, such as from about 0.1 wt % to about 8 wt %, such as from about 0.25 wt % to about 3 wt %, based on the total weight of the fire-resistant composition. In at least one embodiment, the total amount (in wt %) of defoamer(s) in a fire-resistant composition, based on the total weight of the fire-resistant composition, can be 0, 0.25, 0.5, 0.75, 1, 1.5, 2, 2.5, 3, 3.5, 4, 4.5, 5, 5.5, 6, 6.5, 7, 7.5, 8, 8.5, 9, 9.5, 10, 10.5, or 11, or ranges thereof, though other amounts are contemplated. Each of the foregoing numbers can be preceded by the word “about,” “at least about,” “less than about,” or “more than about,” and any of the foregoing numbers can be used singly to describe an open-ended range or in combination to describe a close-ended range.

In some embodiments, a total amount of pigment(s) in fire-resistant compositions described herein can be from about 0 wt % to about 10 wt %, such as from about 0.5 wt % to about 7.5 wt %, such as from about 1 wt % to about 5 wt %, based on the total weight of the fire-resistant composition. In at least one embodiment, the total amount (in wt %) of pigment(s) in a fire-resistant composition, based on the total weight of the fire-resistant composition, can be 0, 0.25, 0.5, 0.75, 1, 1.5, 2, 2.5, 3, 3.5, 4, 4.5, 5, 5,5, 6, 6,5, 7, 7.5, 8, 8.5, 9, 9.5, or 10, or ranges thereof, though other amounts are contemplated. Each of the foregoing numbers can be preceded by the word “about,” “at least about,” “less than about,” or “more than about,” and any of the foregoing numbers can be used singly to describe an open-ended range or in combination to describe a close-ended range.

In some embodiments, a total amount of coalescing agent(s) in fire-resistant compositions described herein can be from about 0 wt % to about 10 wt %, such as from about 0.5 wt % to about 7.5 wt %, such as from about 1 wt % to about 5 wt %, based on the total weight of the fire-resistant composition. In at least one embodiment, the total amount (in wt %) of coalescing agent(s) in a fire-resistant composition, based on the total weight of the fire-resistant composition, can be 0, 0.25, 0.5, 0.75, 1, 1.5, 2, 2.5, 3, 3.5, 4, 4.5, 5, 5.5, 6, 6.5, 7, 7.5, 8, 8.5, 9, 9.5, or 10, or ranges thereof, though other amounts are contemplated. Each of the foregoing numbers can be preceded by the word “about,” “at least about,” “less than about,” or “more than about,” and any of the foregoing numbers can be used singly to describe an open-ended range or in combination to describe a close-ended range.

In some embodiments, a total amount of rheological modifier(s) in fire-resistant compositions described herein can be from about 0 wt % to about 10 wt %, such as from about 0.25 wt % to about 10 wt %, such as from about 0. 5 wt % to about 7 wt %, such as from about 0.75 wt % to about 5 wt %, based on the total weight of the fire-resistant composition. In at least one embodiment, the total amount (in wt %) of rheological modifier(s) in a fire-resistant composition, based on the total weight of the fire-resistant composition, can be 0, 0.25, 0.5, 0.75, 1, 1.5, 2, 2.5, 3, 3.5, 4, 4.5, 5, 5.5, 6, 6.5, 7, 7.5, 8, 8.5, 9, 9.5, or 10, or ranges thereof, though other amounts are contemplated. Each of the foregoing numbers can be preceded by the word “about,” “at least about,” “less than about,” or “more than about,” and any of the foregoing numbers can be used singly to describe an open-ended range or in combination to describe a close-ended range.

The fire-resistant compositions described herein can have an electrical conductivity (wet) of about 32 milliSiemens (mS) or less, such as about 30 mS or less, such as about 28 mS or less, such as about 25 mS or less, such as about 22 mS or less, such as about 20 mS or less, such as about 15 mS or less, such as about 10 mS or less. In at least one embodiment, a fire-resistant composition described herein has an electrical conductivity (wet), in units of mS, that can be 0.5, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, 25, 25.5, 26, 26.5, 27, 27.5, 28, 28.5, 29, 29.5, 30, 30.5, 31, 31.5, or 32, or ranges thereof, though higher or lower electrical conductivities (wet) are contemplated. The electrical conductivity (wet) is determined as described in the examples.

The fire-resistant compositions can have an electrical resistivity (dry) of about 15 megaohms (Me) or more, such as about 20 MΩ or more and/or about 1,000 MΩ or less, such as from about 25 MΩ to about 500 MΩ, such as from about 50 MΩ to about 400 MΩ, such as from about 100 MΩ to about 300 MΩ, such as from about 150 MΩ to about 250 MΩ. In at least one embodiment, a fire-resistant composition described herein has an electrical resistivity (dry), in units of MΩ, that can be 15, 20, 25, 50, 75, 100, 125, 150, 175, 190, 200, 225, 250, 275, 300, 325, 350, 375, 400, 425, 450, 475, 500, 525, 550, 575, 600, 625, 650, 675, 700, 725, 750, 775, 800, 825, 850, 875, 900, 925, 950, 975, or 1,000, or ranges thereof, though higher or lower values are contemplated. The electrical resistivity (dry) is determined by ASTM F3121-17 as described in the examples.

To prepare a fire-resistant composition, the components to be used—for example, particles, intumescent(s), catalyst(s), blowing agent(s), thermoplastic compound(s), and thermoset compound(s)—are mixed together in any suitable order, combination, or sub-combination. Optional additives can also be added to the mixture. Water can also be utilized, if desired, to aid in mixing the components.

Embodiments described herein also generally relate to coated substrates. Coated substrates can include a substrate and one or more fire-resistant compositions of the present disclosure. The fire-resistant composition(s) can be disposed on at least a portion of the substrate by, for example, suitable coating methods. Illustrative, but non-limiting examples of coating methods can include brush coating, spray coating, roller coating, dip coating, curtain coating, and combinations thereof.

Illustrative, but non-limiting, examples of substrates suitable for use can include lignocellulose, wood, fiberglass, glass, metal, clay, shale, and concrete, among others. Wood and lignocellulose substrates can include, but are not limited to, solid lumber, particle board, plywood, medium density fiberboard, hardboard, parallel strand lumber, oriented strand board, and strawboard, among others. The substrate can be flexible or rigid.

The substrate can be a structure or installation that can benefit from fire-resistant properties such as infrastructure equipment, residential building materials and structures, commercial building materials and structures, among other structures and installations. Residential and commercial building materials and structures can include roofing, walls, floors, I-joists, underlayment, and siding. Infrastructure equipment can include utility poles, such as wooden utility poles, and electrical cables, such as those utility poles and cables used for power, telecommunication, and transportation, among other infrastructure equipment. The structures and installations can be new or existing structures or installations.

In use, for example, a fire-resistant composition can be disposed directly on a substrate (such as a structure or installation) to be protected by suitable coating methods such as brush coating, spray coating, or other methods. The fire-resistant composition expands or swells upon exposure to heat caused by, for example, a fire or other heat source. The expansion or swelling of the fire-resistant composition can provide a thermal, protective barrier between the fire and the substrate being protected (in this example, the structure or installation).

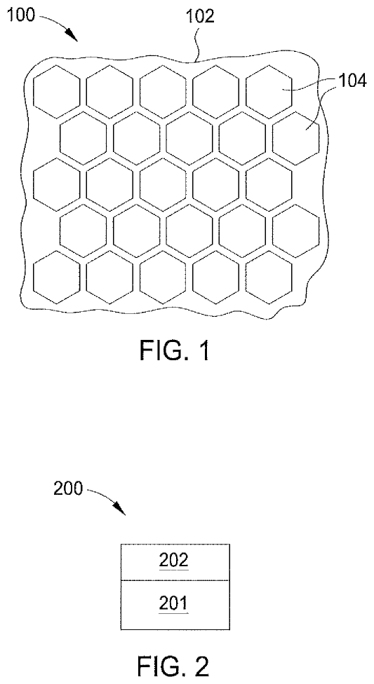

Embodiments described herein also relate to fire-resistant articles used to, for example, cover at least a portion of a structure or installation. The fire-resistant article can be in the form of a covering such as a wrap, a sleeve, a mat, a roll, or the like. In some embodiments, the fire-resistant article includes a flexible or moldable substrate. The flexible substrate can be made of, or include, fiberglass, metal, combinations thereof, among other substrates such as those described herein. In some examples, the flexible substrate has a mesh structure (or open-cell structure) as shown in FIG. 1.

The fire-resistant article also includes a fire-resistant composition described herein. The fire-resistant composition is disposed on at least a portion of the flexible substrate, such as one or more surfaces of the flexible substrate. The fire-resistant composition can be disposed on at least a portion of the flexible substrate by, for example, suitable coating methods. Illustrative, but non-limiting examples of coating methods can include brush coating, spray coating, roller coating, dip coating, curtain coating, and combinations thereof.

FIG. 1 is a top plan view of a fire-resistant article 100 according to at least one embodiment of the present disclosure. The fire-resistant article 100 can be a flexible substrate having a fire-resistant composition disposed thereon 102. FIG. 2, discussed below, shows an example of a flexible substrate having a fire-resistant composition disposed thereon according to at least one embodiment. Referring back to FIG. 1, the flexible substrate may be made of, or include, those substrates described above. As shown, the article 100 has a mesh structure or open-cell structure indicated by voids 104. Although the voids 104 are shown as having a hexagonal shape, the voids 104 can be of any suitable shape, such as circle, oval, square, or other polygon, and combinations thereof, and can be arranged in a random or irregular arrangement. The voids 104 can enable improved moisture control. As described herein, the fire-resistant article 100 can be in the form of a wrap, a sleeve, a mat, a roll, or the like. In some examples, the fire-resistant article 100 is free of voids 104.

FIG. 2 is a side view of a non-limiting example of a flexible substrate having a fire-resistant composition disposed thereon. The example illustrated in FIG. 2 can represent a side view of a portion of the flexible substrate having a fire-resistant composition disposed thereon 102 shown in FIG. 1. As shown, the fire-resistant composition 202 forms a layer on at least a portion of the flexible substrate 201. Although FIG. 2 shows the fire-resistant composition 202 disposed on a single surface of the flexible substrate 201, the fire-resistant composition 202 can be disposed on multiple surfaces of the flexible substrate 201. Additionally, the fire-resistant composition 202 can be disposed within portions of the flexible substrate 201. For example, when a flexible substrate includes pores, multiple layers, or the like, a fire-resistant composition can be disposed on one or more surfaces, within one or more pores, on or in one or more layers, and combinations thereof.

In use, for example, a fire-resistant article (such as fire-resistant article 100) in the form of a wrap, sleeve, mat, or roll, can be affixed to a structure or installation that can benefit from fire-resistant properties such as infrastructure equipment, residential building materials and structures, commercial building materials and structures, among other structures and installations. Residential and commercial building materials and structures can include roofing, walls, floors, I-joists, underlayment, and siding. Infrastructure equipment can include utility poles, such as wooden utility poles, and electrical cables, such as those utility poles and cables used for power, telecommunication, and transportation, among other infrastructure equipment. The structures and installations can be new or existing structures or installations. When heated, the fire-resistant composition 202, disposed on the flexible substrate 201, expands to fill the voids 103 of the fire-resistant article 100. The expansion or swelling of the fire-resistant composition can provide a thermal, protective barrier between the fire and the structure or installation.

The following examples are put forth so as to provide those of ordinary skill in the art with a complete disclosure and description of how to make and use embodiments of the present disclosure, and are not intended to limit the scope of embodiments of the present disclosure. Efforts have been made to ensure accuracy with respect to numbers used but some experimental errors and deviations should be accounted for.

### EXAMPLES

### Example Composition

An example fire-resistant composition (Example 1-1) and a comparative example fire resistant composition (Comparative Example 1-1, C.Ex. 1-1) were prepared using the components shown in Table 1A. Disperbyk-190 is a dispersant. Byk-037 is a volatiles-free, silicone-containing defoamer based on mineral oil. Iron oxide is used as a pigment. Melamine is a blowing agent. Microna 3/Imasco 5H is a blowing agent. Exolit AP 422 is a fine-particle ammonium polyphosphate. XB-91M0 is a phenolic thermoset compound. Covinax FR-A 707 is a styrene acrylic thermoplastic compound. 2,2,4-trimethyl-1,3-pentanediol monoisobutyrate is a coalescing agent. Grafguard 200-100N is expandable graphite used as an intumescent. Thixol 53 L is a liquid acrylic thickener used as a rheological modifier. E-spheres SLG are hollow ceramic microspheres (particles). The typical particle size distribution of the E-spheres SLG is: below 106 μm: 0-35%; 106-300 μin: 64-100%; and over 300 μm: 0-1%.

TABLE 1A

| | | Ex. 1-1 | C.Ex. 1-1 |
|---|---|---|---|
| | Component | (Wt %) | (Wt %) |
| Viscosity | Water | 12.491 | 14.446 |
| controller | | | |
| Dispersant | Disperbyk-190 | 0.795 | 0.795 |
| Defoamer | Byk-037 | 0.199 | 0.199 |
| Pigment | Iron Oxide | 1.955 | — |
| Blowing agent | Melamine | 3.865 | 3.865 |
| Blowing agent | Microna 3 or Imasco 5H | 7.712 | 7.712 |
| Catalyst/Blowing | Exolit AP 422 | 7.712 | 7.712 |
| agent | | | |
| Binder | XB-91MO | 9.482 | 9.482 |
| Binder | Covinax FR-A 707 | 37.927 | 37.927 |
| Coalescing agent | 2,2,4-Trimethyl-1,3-pentanediol | 1.427 | 1.427 |
| | monoisobutyrate | | |
| Particles | E-spheres SLG | 6.000 | — |
| Expandable | Grafguard 200-100N | 9.442 | 15.442 |
| graphite | | | |
| Rheological | Thixol 53 L | 0.993 | 0.993 |
| modifier | | | |
| | Total | 100 | 100 |

The example fire-resistant composition was made by charging the components in the order listed in Table 1A while stirring or agitating at a temperature of about 21° C. to about 27° C., ensuring that the components were evenly dispersed.

Selected properties of the example fire-resistant composition (Example 1-1) and the comparative example fire resistant composition (Comparative Example 1-1) are shown in Table 1B.

TABLE 1B

| Properties | Ex. 1-1 | C.Ex. 1-1 |
|---|---|---|
| Electrical conductivity (wet), mS | 20.6 | 32.1 |
| Electrical resistivity (dry), MΩ | 6.3 | 190 |
| Viscosity (20 rpm, 25° C.), cPs | 9,300 | 28,100 |

The wet electrical conductivities of the example composition and comparative composition were determined according to the following procedure. A sample of about 100-150 mL of the composition is placed in a beaker and equilibrated to about 25° C. A calibrated conductivity probe that has been equilibrated to about 25° C. is submerged into the sample and the conductivity is measured. Wet electrical conductivity is the conductivity of the composition as-is, before evaporating all of the water and moisture from the composition.

Electrical resistivity (dry) is the resistivity of the composition after removing water and moisture from the composition. Electrical resistivity (dry) was determined by the following procedure. A continuous film of the composition is applied onto a Teflon sheet and allowed to dry. After drying, the film is peeled off an cut into a 5-inch by 12-inch sample. Clamps of a MegaOhm meter are attached to the end of the film and placed on a wood surface. The voltage of the MegaOhm meter is set to 250 V DC and the measurement is recorded.

The viscosities of the example and comparative compositions were determined using a Brookfield viscometer at 25° C. and a spindle speed of 20 rpm.

The wet electrical conductivities of the example fire-resistant composition (Example 1-1) and the comparative composition (Comparative Example 1-1) was determined to be about 20.6 milliSiemens (mS) and about 32.1 mS, respectively. The significantly lower electrical conductivity of the example fire-resistant composition indicated that compositions described herein can provide increased safety when, for example, live power lines are serviced. In addition, compositions having lower electric conductivity can be beneficial in limiting arcs and electrical flash events.

Further, the electrical resistivity of Example 1-1 was determined to be significantly higher than Comparative Example 1-1. Here, the electrical resistivity of Example 1-1 and Comparative Example 1-1 were determined to be about 190 MΩ and about 6.3 MΩ, representing a percent increase in resistivity of about 2,916%. The significantly lower electrical conductivity of the example fire-resistant composition indicated that compositions described herein can provide increased safety when, for example, live power lines are serviced.

In addition, the viscosity of the example composition (Example 1-1) was significantly lower than the comparative composition (Comparative Example 1-1). Here, the viscosities of Example 1-1 and Comparative Example 1-1 were determined to be about 9,300 cPs and about 28,100 cPs, respectively. The viscosity can be adjusted, depending on the application with the use of rheological modifier.

### Example Coated Substrate

The example composition (Example 1-1) and the comparative composition (Comparative Example 1-1) were then used, individually, to fabricate example and comparative coated substrates. The example and comparative coated substrates were formed by the following non-limiting procedure. A fiberglass substrate was dipped into the example fire-resistant composition or the comparative fire-resistant composition formed by the procedure described above. The dip-coated fiberglass substrates were then run through a roller bar system set at a gap of about 2 mm. At this stage, each fiberglass substrate is coated with the fire-resistant composition as a continuous film. Each coated substrate was then conveyed through an air knife system. After conveying through the air knife, each coated substrate was an open mesh (or open cell) structure having voids. Each coated substrate was then allowed to dry/cure, under ambient conditions, for about 24 hours to about 72 hours.

Two samples of the example coated substrate and two samples of the comparative example coated substrate were then subjected to a burn test. A 12-inch by 12-inch sample of each coated substrate was cut and used for the burn test. The burn test was performed according to the following procedure. A heat source coupled to a double panel furnace was ignited and allowed to equilibrate to a desired temperature for about 20 minutes. While the furnace equilibrated, each sample was secured to a steel holding apparatus and covered in an insulating material. Once the heat source had equilibrated, the insulating material was removed from each sample and the heat source was pushed to a position −12 inches away from the surface of each sample. A timer was started and each sample was exposed to the heat source for about 5 minutes. After about 5 minutes, the Bunsen torch was ignited and the each sample was exposed to both the double panel furnace and the Bunsen torch for an additional 5 minutes. After testing for a total of about 10 minutes, the flame of the Bunsen torch was extinguished, and the panel/sample was allowed to cool prior to removal.

Table 2 shows results of the burn test for two example coated substrates (Examples 2-1 and 2-2, which are Ex. 2-1 and Ex. 2-2, respectively) and two comparative example coated substrates (Comparative Examples 2-1 and 2-2, which are C.Ex. 2-1 and C.Ex. 2-2, respectively). The post-burn panel thickness represents the panel and the char layer formed by exposing the coated panel to the burn test.

TABLE 2

| | | | Coated | Post-burn | |
|---|---|---|---|---|---|
| | | | panel | panel | Char layer |
| | Pre-burn | Post-burn | thickness, | thickness, | detached from |
| Example | weight, g | weight, g | mm | mm | substrate |
| Ex. 2-1 | 203.2 | 184.1 | 3.25 | 3.97 | No |
| Ex. 2-2 | 218.5 | 177.5 | 3.21 | 3.97 | No |
| C.Ex. 2-1 | 235.1 | 213.6 | 3.28 | 8.73 | No |
| C.Ex. 2-2 | 244.8 | 218.7 | 3.32 | 12.7 | No |

Overall, the compositions of the present disclosure (Examples 2-1 and 2-2) show dramatically different post-burn thicknesses (char layer) than the comparative examples. For example, and as shown in Table 2, the post-burn panel thickness for Examples 2-1 and 2-2 were determined to be about 3.97 mm, while the post-burn panel thickness for Comparative Examples 2-1 and 2-2 were determined to be about 8.73 and about 12.7 mm, respectively. That is, the thickness of the Examples were less than about 50% (and even less than about 66%) of the thickness of the Comparative Examples after the burn test. Although Examples 2-1 and 2-2 included about 20% less coating and were only about one-third to about one-half as thick as the Comparative Examples 2-1 and 2-2, Examples 2-1 and 2-2 generated temperature profiles that were at least equivalent to the Comparative Examples 2-1 and 2-2. Moreover, and as described above, the example compositions, example coated substrates, and example articles of the present disclosure have a lower conductivity than conventional technologies.

Embodiments described herein relate to fire-resistant compositions and to coated substrates and articles comprising such compositions. Unlike current technologies, the fire-resistant compositions described herein can have low electrical conductivity while being suitable for a large variety of substrates such as wood and metal, among others. In addition, the fire-resistant compositions described herein can be lighter in weight relative to conventional fire-resistant compositions.

### EMBODIMENTS LISTING

The present disclosure provides, among others, the following aspects, each of which can be considered as optionally including any alternate embodiments:

Clause 1. A fire-resistant composition, comprising:
a plurality of particles, each particle of the plurality of particles comprising a core and a shell, the shell comprising ceramic, glass, polymer, resin, or combinations thereof;
an intumescent;
a blowing agent;
a catalyst; and
a binder comprising:
   a thermoplastic compound; and
   a thermoset compound.

Clause 2. The fire-resistant composition of Clause 1, wherein the core of each particle is at least partially hollow.

Clause 3. The fire-resistant composition of Clause 1 or Clause 2, wherein the plurality of particles have an average particle size of about 0.5 μm to about 2,000 μm.

Clause 4. The fire-resistant composition of any one of Clauses 1-3, wherein the plurality of particles are present in an amount of about 0.5 wt % to about 20 wt % based on a total weight of the fire-resistant composition.

Clause 5. The fire-resistant composition of any one of Clauses 1-4, wherein the intumescent is present in an amount of about 5 wt % to about 30 wt % based on a total weight of the fire-resistant composition.

Clause 6. The fire-resistant composition of any one of Clauses 1-5, wherein the binder is present in an amount of about 10 wt % to about 80 wt % based on a total weight of the fire-resistant composition.

Clause 7. The fire-resistant composition of any one of Clauses 1-6, wherein the thermoplastic compound is selected from the group consisting of polyvinyl acetate, poly(methyl acrylate), poly(methyl methacrylate), poly(ethyl acrylate), poly(ethyl methacrylate), poly(n-butyl acrylate), poly(n-butyl methacrylate), poly(isobutyl acrylate), poly(isobutyl methacrylate), poly(tert-butyl acrylate), poly(tert-butyl methacrylate), poly(2-hydroxyethyl acrylate), poly(2-hydroxyethyl methacrylate), poly(2-hydroxypropyl acrylate), poly(2-hydroxypropyl methacrylate), poly(2-ethylhexyl acrylate), poly(2-ethylhexyl methacrylate), and combinations thereof.

Clause 8. The fire-resistant composition of any one of Clauses 1-7, wherein the thermoset compound is selected from the group consisting of phenol formaldehyde, urea formaldehyde, melamine formaldehyde, melamine reinforced urea formaldehyde, isocyanate reinforced urea formaldehyde resin, resorcinol formaldehyde resin, polyacrylic latex resin, isocyanate resin, an organopolysiloxane, ethylene glycol, bisphenol-A epoxy resins, bisphenol-F epoxy resins, unsaturated polyesters, and combinations thereof.

Clause 9. The fire-resistant composition of any one of Clauses 1-9, wherein the blowing agent is selected from the group consisting of melamine, urea, butyl urea, alumina trihydrate, dicyandiamide, benzene sulfonyl-hydrazide, azobisisobutyronitrile, 1,1-azobisformamide, 4,4′-oxybis(benzene sulfonhydrazide), dinitroisopentamethylene tetraamine, and combinations thereof.

Clause 10. The fire-resistant composition of any one of Clauses 1-8, wherein the catalyst is selected from the group consisting of perchloric acid, hydroiodic acid, hydrobromic acid, sulfuric acid, hydrochloric acid, nitric acid, sulfurous acid, phosphoric acid, nitrous acid, sulfonic acid, hydrochloric acid, sulfuric acid, phosphoric acid, formic acid, acetic acid, maleic acid, malic acid, tartaric acid, citric acid, ammonium phosphates, metal phosphates, paratoluene sulfonic acid, and combinations thereof.

Clause 11. The fire-resistant composition of any one of Clauses 1-10, wherein:

the blowing agent is present in an amount of about 1 wt % to about 35 wt % based on a total weight of the fire-resistant composition;

the catalyst is present in an amount of about 1 wt % to about 20 wt % based on the total weight of the fire-resistant composition; or a combination thereof.

Clause 12. The fire-resistant composition of any one of Clauses 1-11, further comprising:
a coalescing agent;
a rheological modifier; or
a combination thereof.

Clause 13. The fire-resistant composition of Clause 12, wherein:
when the coalescing agent is present, an amount of the coalescing agent in the fire-resistant composition is from about 0.5 wt % to about 15 wt %, based on a total weight of the fire-resistant composition;
when the rheological modifier is present, an amount of the rheological modifier in the fire-resistant composition is from about 0.25 wt % to about 10 wt %, based on the total weight of the fire-resistant composition; or
a combination thereof.

Clause 14. The fire-resistant composition of any one of Clauses 1-13, wherein:
the particles are present in an amount of about 5 wt % to about 20 wt % based on a total weight of the fire-resistant composition;
the intumescent is present in an amount of about 5 wt % to about 25 wt % based on the total weight of the fire-resistant composition; and
the binder is present in an amount of about 15 wt % to about 50 wt % based on the total weight of the fire-resistant composition.

Clause 15. A coated substrate, comprising:
a substrate; and
a fire-resistant composition disposed over at least a portion of the substrate, the fire-resistant composition comprising:
   particles having a core-shell structure, the shell comprising ceramic, glass, polymer, resin, or combinations thereof;
   an intumescent;
   a blowing agent;
   a catalyst; and
   a binder comprising:
      a thermoplastic compound; and
      a thermoset compound.

Clause 16. The coated substrate of Clause 15, wherein the substrate comprises wood, fiberglass, glass, metal, clay, or shale.

Clause 17. The coated substrate of Clause 15 or Clause 16, wherein:
the thermoplastic compound is selected from the group consisting of polyvinyl acetate, poly(methyl acrylate), poly(methyl methacrylate), poly(ethyl acrylate), poly(ethyl methacrylate), poly(n-butyl acrylate), poly(n-butyl methacrylate), poly(isobutyl acrylate), poly(isobutyl methacrylate), poly(tert-butyl acrylate), poly(tert-butyl methacrylate), poly(2-hydroxyethyl acrylate), poly(2-hydroxyethyl methacrylate), poly(2-hydroxypropyl acrylate), poly(2-hydroxypropyl methacrylate), poly(2-ethylhexyl acrylate), poly(2-ethylhexyl methacrylate), and combinations thereof;
the thermoset compound is selected from the group consisting of phenol formaldehyde, urea formaldehyde, melamine formaldehyde, melamine reinforced urea formaldehyde, isocyanate reinforced urea formaldehyde resin, resorcinol formaldehyde resin, polyacrylic latex resin, isocyanate resin, an organopolysiloxane, ethylene glycol, bisphenol-A epoxy resins, bisphenol-F epoxy resins, unsaturated polyesters, and combinations thereof;
the blowing agent is selected from the group consisting of melamine, urea, butyl urea, alumina trihydrate, dicyandiamide, benzene sulfonyl-hydrazide, azobisisobutyronitrile, 1,1-azobisformamide, 4,4′-oxybis(benzene sulfonhydrazide), dinitroisopentamethylene tetraamine, and combinations thereof;
the catalyst is selected from the group consisting of perchloric acid, hydroiodic acid, hydrobromic acid, sulfuric acid, hydrochloric acid, nitric acid, sulfurous acid, phosphoric acid, nitrous acid, sulfonic acid, hydrochloric acid, sulfuric acid, phosphoric acid, formic acid, acetic acid, maleic acid, malic acid, tartaric acid, citric acid, ammonium phosphates, metal phosphates, paratoluene sulfonic acid, and combinations thereof; or
combinations thereof.

Clause 18. The coated substrate of any one of Clauses 15-17, wherein the particles are at least partially hollow.

Clause 19. A fire-resistant article for covering at least a portion of a structure, comprising:
a flexible substrate; and
a fire-resistant composition disposed on at least a portion of the flexible substrate, the fire-resistant composition comprising:
   particles having a core-shell structure, the shell comprising ceramic, glass, polymer, resin, or combinations thereof, the particles having an average particle size of about 0.5 μm to about 2,000 μm;
   an intumescent;
   a blowing agent; and
   a binder comprising:
      a thermoplastic compound; and
      a thermoset compound.

Clause 20. The fire-resistant article of Clause 19, wherein:

the fire-resistant article is in the form of a wrap, a sleeve, a matt, or a roll; and the fire-resistant article has an open cell structure or a mesh structure.

As is apparent from the foregoing general description and the specific aspects, while forms of the aspects have been illustrated and described, various modifications can be made without departing from the spirit and scope of the present disclosure. Accordingly, it is not intended that the present disclosure be limited thereby. Likewise, the term “comprising” is considered synonymous with the term “including.” Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “Is” preceding the recitation of the composition, element, or elements and vice versa, such as the terms “comprising,” “consisting essentially of,” “consisting of” also include the product of the combinations of elements listed after the term.

For purposes of this present disclosure, and unless otherwise specified, all numerical values within the detailed description and the claims herein are modified by “about” or “approximately” the indicated value, and consider experimental error and variations that would be expected by a person having ordinary skill in the art. For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

As used herein, the indefinite article “a” or “an” shall mean “at least one” unless specified to the contrary or the context clearly indicates otherwise. For example, aspects comprising “a monomer” include aspects comprising one, two, or more monomers, unless specified to the contrary or the context clearly indicates only one monomer is included.

While the foregoing is directed to aspects of the present disclosure, other and further aspects of the disclosure may be devised without departing from the basic scope thereof, and the scope thereof is determined by the claims that follow.

What is claimed is:

1. A fire-resistant composition, comprising:
a plurality of particles, each particle of the plurality of particles comprising a core and a shell, the shell comprising ceramic, glass, polymer, resin, or combinations thereof;
an intumescent;
a blowing agent;
a catalyst; and
a binder comprising:
a thermoplastic compound; and
a thermoset compound.

2. The fire-resistant composition of claim 1, wherein the core of each particle is at least partially hollow.

3. The fire-resistant composition of claim 1, wherein the plurality of particles have an average particle size of about 0.5 μm to about 2,000 μm.

4. The fire-resistant composition of claim 1, wherein the plurality of particles are present in an amount of about 0.5 wt % to about 20 wt % based on a total weight of the fire-resistant composition.

5. The fire-resistant composition of claim 1, wherein the intumescent is present in an amount of about 5 wt % to about 30 wt % based on a total weight of the fire-resistant composition.

6. The fire-resistant composition of claim 1, wherein the binder is present in an amount of about 10 wt % to about 80 wt % based on a total weight of the fire-resistant composition.

7. The fire-resistant composition of claim 1, wherein the thermoplastic compound is selected from the group consisting of polyvinyl acetate, poly(methyl acrylate), poly(methyl methacrylate), poly(ethyl acrylate), poly(ethyl methacrylate), poly(n-butyl acrylate), poly(n-butyl methacrylate), poly(isobutyl acrylate), poly(isobutyl methacrylate), poly(tert-butyl acrylate), poly(tert-butyl methacrylate), poly(2-hydroxyethyl acrylate), poly(2-hydroxyethyl methacrylate), poly(2-hydroxypropyl acrylate), poly(2-hydroxypropyl methacrylate), poly(2-ethylhexyl acrylate), poly(2-ethylhexyl methacrylate), and combinations thereof.

8. The fire-resistant composition of claim 1, wherein the thermoset compound is selected from the group consisting of phenol formaldehyde, urea formaldehyde, melamine formaldehyde, melamine reinforced urea formaldehyde, isocyanate reinforced urea formaldehyde resin, resorcinol formaldehyde resin, polyacrylic latex resin, isocyanate resin, an organopolysiloxane, ethylene glycol, bisphenol-A epoxy resins, bisphenol-F epoxy resins, unsaturated polyesters, and combinations thereof.

9. The fire-resistant composition of claim 1, wherein the blowing agent is selected from the group consisting of melamine, urea, butyl urea, alumina trihydrate, dicyandiamide, benzene sulfonyl-hydrazide, azobisisobutyronitrile, 1,1-azobisformamide, 4,4′-oxybis(benzene sulfonhydrazide), dinitroisopentamethylene tetraamine, and combinations thereof.

10. The fire-resistant composition of claim 1, wherein the catalyst is selected from the group consisting of perchloric acid, hydroiodic acid, hydrobromic acid, sulfuric acid, hydrochloric acid, nitric acid, sulfurous acid, phosphoric acid, nitrous acid, sulfonic acid, hydrochloric acid, sulfuric acid, phosphoric acid, formic acid, acetic acid, maleic acid, malic acid, tartaric acid, citric acid, ammonium phosphates, metal phosphates, paratoluene sulfonic acid, and combinations thereof.

11. The fire-resistant composition of claim 1, wherein:
the blowing agent is present in an amount of about 1 wt % to about 35 wt % based on a total weight of the fire-resistant composition;
the catalyst is present in an amount of about 1 wt % to about 20 wt % based on the total weight of the fire-resistant composition; or a combination thereof.

12. The fire-resistant composition of claim 1, further comprising:
a coalescing agent;
a rheological modifier; or
a combination thereof.

13. The fire-resistant composition of claim 12, wherein:
when the coalescing agent is present, an amount of the coalescing agent in the fire-resistant composition is from about 0.5 wt % to about 15 wt %, based on a total weight of the fire-resistant composition;
when the rheological modifier is present, an amount of the rheological modifier in the fire-resistant composition is from about 0.25 wt % to about 10 wt %, based on the total weight of the fire-resistant composition; or
a combination thereof.

14. The fire-resistant composition of claim 1, wherein:
the particles are present in an amount of about 5 wt % to about 20 wt % based on a total weight of the fire-resistant composition;
the intumescent is present in an amount of about 5 wt % to about 25 wt % based on the total weight of the fire-resistant composition; and
the binder is present in an amount of about 15 wt % to about 50 wt % based on the total weight of the fire-resistant composition.

15. A coated substrate, comprising:
a substrate; and
a fire-resistant composition disposed over at least a portion of the substrate, the fire-resistant composition comprising:
particles having a core-shell structure, the shell comprising ceramic, glass, polymer, resin, or combinations thereof;
an intumescent;
a blowing agent;
a catalyst; and
a binder comprising:
a thermoplastic compound; and
a thermoset compound.

16. The coated substrate of claim 15, wherein the substrate comprises wood, fiberglass, glass, metal, clay, or shale.

17. The coated substrate of claim 15, wherein:
the thermoplastic compound is selected from the group consisting of polyvinyl acetate, poly(methyl acrylate), poly(methyl methacrylate), poly(ethyl acrylate), poly(ethyl methacrylate), poly(n-butyl acrylate), poly(n-butyl methacrylate), poly(isobutyl acrylate), poly(isobutyl methacrylate), poly(tert-butyl acrylate), poly(tert-butyl methacrylate), poly(2-hydroxyethyl acrylate), poly(2-hydroxyethyl methacrylate), poly(2-hydroxypropyl acrylate), poly(2-hydroxypropyl methacrylate), poly(2-ethylhexyl acrylate), poly(2-ethylhexyl methacrylate), and combinations thereof;
the thermoset compound is selected from the group consisting of phenol formaldehyde, urea formaldehyde, melamine formaldehyde, melamine reinforced urea formaldehyde, isocyanate reinforced urea formaldehyde resin, resorcinol formaldehyde resin, polyacrylic latex resin, isocyanate resin, an organopolysiloxane, ethylene glycol, bisphenol-A epoxy resins, bisphenol-F epoxy resins, unsaturated polyesters, and combinations thereof;
the blowing agent is selected from the group consisting of melamine, urea, butyl urea, alumina trihydrate, dicyandiamide, benzene sulfonyl-hydrazide, azobisisobutyronitrile, 1,1-azobisformamide, 4,4′-oxybis(benzene sulfonhydrazide), dinitroisopentamethylene tetraamine, and combinations thereof;
the catalyst is selected from the group consisting of perchloric acid, hydroiodic acid, hydrobromic acid, sulfuric acid, hydrochloric acid, nitric acid, sulfurous acid, phosphoric acid, nitrous acid, sulfonic acid, hydrochloric acid, sulfuric acid, phosphoric acid, formic acid, acetic acid, maleic acid, malic acid, tartaric acid, citric acid, ammonium phosphates, metal phosphates, paratoluene sulfonic acid, and combinations thereof; or combinations thereof.

18. The coated substrate of claim 15, wherein the particles are at least partially hollow.

19. A fire-resistant article for covering at least a portion of a structure, comprising:
a flexible substrate; and
a fire-resistant composition disposed on at least a portion of the flexible substrate, the fire-resistant composition comprising:
particles having a core-shell structure, the shell comprising ceramic, glass, polymer, resin, or combinations thereof, the particles having an average particle size of about 0.5 μm to about 2,000 μm;
an intumescent;
a blowing agent; and
a binder comprising:
a thermoplastic compound; and
a thermoset compound.

20. The fire-resistant article of claim 19, wherein:
the fire-resistant article is in the form of a wrap, a sleeve, a matt, or a roll; and
the fire-resistant article has an open cell structure or a mesh structure.
